(19) United States
(12) Patent Application Publication
(10) Pub. No.: US 2015/0370930 A1
(43) Pub. Date: Dec. 24, 2015

(54) User-friendly system using temporal logic, numerical and probabilistic constraints for the complex sequencing of events over time intervals, its optimization and its modeling (also applicable to catastrophic events)

(71) Applicant: Olivier L. Dehousse, New York, NY (US)

(72) Inventor: Olivier L. Dehousse, New York, NY (US)

(21) Appl. No.: 14/120,731

(22) Filed: Jun. 23, 2014

(51) Int. Cl. G06F 17/50; G06N 7/00; G06F 17/18

(52) U.S. Cl. CPC G06F 17/5009; G06F 17/18; G06N 7/005

(57) ABSTRACT

Among various approaches to intervals sequencing modeling and optimizations over time (traditionally numerical and logical optimization are separated fields), such as numerical optimization which advantages are to offer a quantified approach to problem solving almost without limits, but within range of specific applications, or optimization under logical constraints, we present here an original approach, which goal is to combine in a structured and easier to use way, logical and numerical constraints, into one original method, that will accumulate the benefits of both approaches to intervals sequencing problem solving, or even more, for the purpose of sequencing optimization over time, and modeling (including catastrophic events modeling). Our method also aims to support manager and systems choices in their respective search for problem solving of intervals optimization sequencing and is capable to combine an approach of numerical modeling and higher degree of expressiveness, making it easy to use.

### CROSS-REFERENCE

Ser. No. 13,068/193 (same owner)

### FEDERALLY SPONSORED RESEARCH

not applicable

### SEQUENCE LISTING OR PROGRAM not applicable—(see explanatory tables in section 8)

### BACKGROUND

We present an original method to support manager choices in their search for solutions to problems of intervals (or also tasks) optimization sequencing (or also ordering) under constraints, responding to complex numerical (and logical) constraints, which could be either planned or based on real time estimates, otherwise only accessible to highly specialized mathematicians.

Among various types of sequencing modeling and optimizations, we have seen that authors have traditionally kept separated numerical (or quantitative) optimization from logical optimization. The advantages of numerical optimization is that it offers a quantified approach to problem solving almost without limits and within a range of applications specific to a model, but these models are usually much more difficult to comprehend and the artifacts available to increase the expressivity in such numerical models are lacking, and making them more difficult to use. These models are typically limited to specific areas of mathematical optimization.

Although logical systems do generally not offer any quantified considerations—in specific when considering complex sequencing or ordering problems—, they usually provide other advantages such as allowing for a more abstract way to describe a problem and offering solutions using a set of logical propositions; however, their resolutions is usually rather complex, in the sense that it typically requires complex algorithms.

Nevertheless, such systems also offer various modeling options, used to integrate the problem's constraints, that are typically easier to comprehend by offering a higher expressivity. We noticed that when the constraints are discontinued, a inference logic does not work, and therefore is not part of our model.

We offer here an original approach, which goal is to combine these two views in providing one original method unifying the benefits of both views, and potentially even much more. In theory, any problem could probably be solved with each type of systems, either numerical or logical, but it can only be done at the price of a highly complex mathematical modeling to integrate all the specificities of a problem.

Conversely, the method presented here, in combining multiple orders of logical and numerical constraints (more information later), will offer many simplifications that will make a problem complexity easier to model. Furthermore, our approach also supports another important aspect; it is that our optimization method will be built in a rather straight forward and much easy to understand modeling, applicable for non-expert about numerical optimization systems.

To complete our model, a calculus of the likelihood of occurrence for future events will also be offered, where past events probability will be used in conjunction with the Bayes's theorem to model or optimize future events sequencing. For the purpose of simplicity, we include this characteristic as a part of what we call later numerical constraints, for which we assume that one of our system baseline will necessarily describe an event as present, past or future, and for which we will also add a probability matrix linking when possible events' probability of occurrences together.

Technical (theoretical) note: our original system will be using the logic embedded into a transitivity table, which is our inference engine logic (or intelligence) to discover new logical constraints and therefore also maintain the consistency of our knowledge base. However, we have found by our own analysis that, such simple logic is showing some flaws, when it comes to propagation of new information. Indeed, if we consider the general set of 3 constraints [<,>,=], and a discontinued set of constraints [<,>] between intervals A and B, then the following set of constraints [,<,>,=] between intervals B and C, from a logical standpoint, we note that the newly discovered constraints between intervals A and C are [<,>,=], which in turn is only true if the set of constraints between interval A and B is [<,>,=], which, shows that without this additional condition, we can create knowledge that is not consistent. Furthermore, if on one side, we consider A [=] B and B [>] C, then it implies A [>] C, however, if we now consider B [>] C and then for instance C [<] A, then it implies also among others A [=] B. This is to show that, therefore, the mathematical property of permutation (and symmetry) in our examples is not respected, which could make the inference of knowledge not aligned with the requirement of being adequate and complete. For instance, we can limit the impact of this problem in limiting the group of constraints and operators, in such that they verify the following properties of reflexivity, symmetry and transitivity, specific to the ensembles theory and/or we should also characterize logical constraints in two groups, which differentiator would be to be allowed to infer new information (or not), however, in any case, the newly inferred information should in turn itself not be allowed to infer new information. The constraints, which then can infer new information, can be seen as stronger or more fundamental, or prevalent to the system. In doing so, we hope that the sets of logical relations (or in this case information) will remain consistent, and in line with our needs, and consequently improve our general system expressivity. (On that topic, an analogy with ensembles theory should show that, in imposing this condition, we are on the conservative side).

### ADVANTAGES

Our method is unique, in the sense that it enhances every possible optimization system that we know off, usually with a very constraint use, and provides the foundation for a tool to support management decisions for managers faced with decisions including solving complex intervals sequencing or scheduling problems, or lay the ground for complex mathematical modeling, including modeling of catastrophic events. These intervals are the abstract representation of objects, which for example can be either time intervals, or tasks over specified time, or even physical intervals (see geometrical problems), without necessitating much further differentiations, except for the characterization of these intervals.

### THE SUMMARY

In summary, the patent here describes a method to support decision making for managers facing complex problems, in the area of intervals sequencing and modeling, that will be built on a combination of logical and quantitative constraints, and as such offers a unique value, for decision support, sequencing optimization and even modeling (including modeling of catastrophic events). Our method is also intended to apply to complex problems of scheduling, and can also be used as the core method of more specialized applications in the area of automated requests or even scheduling.

An example of such an application for our method could be a complex project (or more generally a sequencing of tasks responding to complex parameters), where intervals are time intervals, or tasks, and where the sequencing of intervals representing work elements responding to many complex constraints (of various logical and numerical orders).

This problem will also require that the sequencing of all tasks is optimized in a way responding to complex situation, which otherwise would require complex quantitative mathematical modeling research.

Our system will use a limited number of logical constraints to describe the respective positioning of intervals among themselves. The number of logical constraints (constraints and their respective reciprocates), as well as their choice, will typically depend on the number of intervals or tasks considered and on the level of expressivity that the overall method is trying to achieve. It is important, in building this set of constraints, to consider constraints that are mutually exclusive, so that we can apply rules of transitivity, as our system intelligence will be inferred based on rules of transitivity. While making the choice for the set of logical constraints, it is also important to notice that a large number of these constraints will make the search for an optimal solution in using our method more complex (because the problem is of type NP-Hard).

We also enhance the expressivity of our logical constraints in using a concept called “elasticity”, and which will involved a specific quantitative aspect in the resolution of these logical constraints. This concept of “elasticity” between constraints will enable to dictate precedence rules among all the logical constraints, when there is a choice, in making some logical constraints on specific intervals more likely to be part (or not to be part) of a solution than others. (As such, we increase the expressivity of the logical constraints or our method).

As we plan to leave it up to the user to decide what constraints and how many will need to be used as part of our method, it is also important to note that there is a trade off to make with the building of this part of our system; logical constraints increase the complexity of the logical part of the algorithm to be resolved, but provide the advantages of reducing the complexity of the numerical part of our method, which allows also for some generalization, and at the same time for some abstraction and a higher degree of expressivity.

In our examples (see section 8 of the document), for instance, we will limit the number of possible relationships to describe the relative positioning of intervals to a very small number, down to 3 or 4 essential relations when possible. For instance, the concept of critical path, as used in projects, which describe the necessary time for a specific sequence of related tasks to be completed, becomes rather simple to model and to optimize, with our method.

### EXPLANATORY TABLES

Table 1: Intervals value: this listing is showing all components of intervals properties, and their respective hierarchy that will need to be considered at the time of the resolution.

Table 2: Example 1: this listing is showing a somewhat realistic model where all qualitative and quantitative values apply to real life scenario in the area of project management and optimization of interval sequencing.

Table 3: Example 2: this listing is showing a basic example of a system, including one set of logical constraints of our choice (responding to the properties that we have described earlier), some quantitative constraints and the system resolution.

### DETAILED DESCRIPTION

Our method uses the combination of two views, a logical one and a numerical one, to resolve complex problems of sequencing of intervals.

Our system will use a limited number of logical constraints to describe the respective positioning of intervals among themselves. The number of logical constraints (constraints and their respective reciprocates), as well as their choice, will typically

Our system will use a limited number of logical constraints to describe the respective positioning of intervals among themselves. The number of logical constraints (constraints and their respective reciprocates), as well as their choice, will typically depend on the number of intervals or tasks considered and on the level of expressivity that the overall method is trying to achieve. It is interesting to note, while making these choices, that over 15 constraints, expressivity does not improve substantially.

Our examples—see section 8 of the document—only use a much smaller number of constraints.

We also introduce a concept called “elasticity”, and which will involve specific quantitative aspects in the solution finding among these logical constraints. This concept of “elasticity” between constraints will enable to dictate precedence rules among all the logical constraints, when there is a choice, in making some logical constraints on specific intervals more likely to be part (or not) of an optimized solution than others.

The numerical part allows quantifying different aspects of the intervals and their respective relationships.

In our system, an interval value can hold numerical values (value converted into numerical value) of three types or degrees. One type is an absolute degree (or order) value, which won't change based on the interval position in our system. Another type is a first degree (or order) relative value, which us a value that will change based on the position of the interval within our system. A second degree (or order) relative value is a value as the first degree relative value, although instead of use a fixe baseline to get its value, it will use a relative value between two intervals (This relative distance could be based on baseline—see below—or relative values between intervals first degree relative values). A third order (called elasticity value)—which we can see as a direct application of the concept of second degree relative value—will apply to the logical constraints and allow elasticity to help to establish the precedence of some logical constraints (when they are used as part of an optimized solution) over others, so that they can be integrated into the research of numerical optimizations within our system. Finally, another aspect of the second part of our system is the existence of various baselines.

Baselines are values given by functions, that refer to interval space (the space in which intervals will be positioned as part of the optimized solution), that are defined independently from the final intervals positions, but on which some interval values (interval relative value) will rely to estimate their own value (interval relative value will typically use a baseline value to get their value).

Interval absolute values are typically numbers (e.g. 100, 100,000, or ⅓). Such absolute value interval will embrace a concept of values to indicate if an interval is from the present, part of future. In the case where our system is used as model for predictions, it could also include a likelihood (probability) of occurrence. (In the case of past events, such value could be derived from calculus or rules of thumb, and for future value it will be calculated in using a matrix of probability linking dependent events, based on the Bayes's probability logic.

Intervals relative values are typically variable which take their value directly from the baseline (e.g. day in the month at which an event will take place) or are functions which take their value from the baseline (e.g. a financial function using the yield curve as one of the baseline of our system).

Interval elasticity values are variables that will force when the option is possible for one or some intervals constraints to take instead of another one (or the way around, for one interval constraint not to take place).

Finally, external functions are also part of our system. External functions will be any type of functions, applying to all or any subset of intervals and all or any subset of interval values (absolute value, first degree relative value and second degree relative value).

They will need to be considered when calculating the numerical side of the optimized solution of our system.

(External functions in our system will apply to entire baseline or only to some parts of baseline separately and are set of functions that will need to be optimized).

The possibilities for external functions, as well as any other categories of interval variables, to be weighted (by user) with different value at different times, providing different optimized solutions, is also an inherent part of our system.

The resolution algorithm of our system will take place in two intricate different steps, those steps are: in a first time, evaluating all the logical solution of our system in using transitivity to infer new information, and in a second time using each of these different logical solutions to provide a specific set of numerical equation to optimize. The optimized solution will be the solution to our system (logical and numerical) that is optimal.

For instance, our system will be able to translate high level requirements—translating means here to model in logical and numerical constraints in our system—such as “the sequence of events needs to respond to rules such as selected types of event need to occur only 3 times consecutively in specific sequences, and that all selective type of event occurs in the first ¾ of all sequences of our interval sequencing problem. Our system will allow for some functions to be built by the end users and will offer pre-built in functions and logical constraints (for instance such as responding to the logic from the example below), for instance for a user to pre-select from a catalog.

Some weights (as applying on functions as well as on intervals values and making some functions and interval values more important than others) should be modifiable at the specific requests of a user. As different weights are applied, different optimal solutions might be generated.

For ease of use considerations, for instance, it is not clear if the system should calculate in advance various solutions from various weights or if the system should calculate these solutions as they apply to the weights changes on the fly. As such, a combination of both will probably be offered.

Furthermore, our system and its resolution will allow for multiple systems (per the description from above) to be grouped into one system of systems and to be resolved (find a set of optimal solutions) for system of systems.

As part of such system of systems, external functions (per our description from above) can also operate on specific elements of the system of systems (which we can call “vertical” constraints, as opposed to the constraints from our system per our description from above).

It is also our intend, specifically to make our method even easier to used, to offer sets of preconfigured numerical functions, that can be applied to either baseline or even intervals properties. (One can easily think of a standard calendar for standard baseline related to time, and some more complex numerical functions—for example a heat diffusion equation—as the characteristics under which specific intervals—in this example we mean physical intervals—of our system will need to be sequenced to be optimized).

### OPERATION

The process that we are introducing requires the user to know how many tasks the system needs to operate on. The user will also need to have established some logical constraints between intervals or tasks, which he should find easy to use, due to high degree of expressivity of our model. Some constraints are of a logical type. Furthermore, some of these logical constraints can also be qualified with our concept of elasticity. Finally, quantitative value will be introduced in our system, to qualify some of the intervals or tasks properties in terms of a) absolute values and b) relative values (per our description before). The algorithm will find all optimal solutions, will be easy to use. This algorithm can produce an optimized solution for many real life situations, which require an optimal ordering of tasks under real life constraints that can be translated into the logical and numerical constraints of our method.

### CONCLUSIONS

We present here an innovative method of mathematical modeling capable of considering some complex aspects of the resolution and optimization of intervals sequencing or tasks ordering problems, that is applicable in the area of management support decision, for instance in complex projects, or even scheduling problems, where as such intervals would represent tasks to order, or even subtasks to order, as a solution that is optimal under the constraints, made of a combination of logical or numerical type and allowing for very high expressivity and relatively easy to use for non specialist in numerical optimization modeling.

TABLE 1

| | | |
|---|---|---|
| Sequence of calculation | Interval Logic | |
| | Logical constraints | Example: At the same |
| | | time, Preceding, |
| | | Following . . . |
| | Interval values | |
| | Level 1 | Baselines |
| | Level 2 | Absolute Values |
| | Level 3 | Relative value - First |
| | | order |
| | Level 4 | Relative value - Second |
| | | order |
| | Level 5 | Elasticity |
| | Level F1 | External function |
| | | (Example: linear function |
| | | solve, minimize or |
| | | maximize) |
| | Level F2 | External function - |
| | | System of systems |

TABLE 2
Example - Problem 1

System uses 3 types of logical constraints:

Preceding, Following, Parallel

System intervals (which each represent a task - limited to 10, but could be 100 s):
A1, A2, A3, A4, A5, A6, A7, A8, A9, A10
Given logical constraints in system (e.g. manager knows by experience that these are some constraints
that need to be respected, for instance the task A1 must

| | A1 precedes A2; A1 precedes A3; A1 precedes A4; A5 follows A1; | |
|---|---|---|
| | A9 precedes A10; A7 follows A3 | |
| Numerical Constraints: | Type Baseline: B1-B1 is 1 . . . 10 | |
| | Type Baseline: B2-B2 is 1 . . . 31 | |
| | Intervals properties (absolute value): Number of days that each | |
| | activity will take: A1: D(5); A2: D(7); A3: D(2); A4: D(1); A5: D(1); | |
| | A6: D(1); A7: D(1); A8: D(1); A9: D(1); A10: D(1) | |
| | Intervals properties (relative value): | |
| | 1. | Project is very risky, and PM needs to show progress in |
| | | spending as less as possible. This translates into a numerical |
| | | constraint of the type: Function Sum of estimated cost |
| | | needs to grow as slow as possible. So, the cost of the first |
| | | interval 1; interval 1 and 2; interval 1, 2 and 3; 1, 2, 3 and 4; . . . |
| | | until 7 need to be minimized for the optimal solution |
| | 2. | The complexity of the project makes it riskier if the number |
| | | of tasks handled in parallel is too high. We limit this |
| | | complexity in imposing a constraint of the type: Cost of |
| | | parallel tasks can't go above 5. If any solution offered has |
| | | parallel tasks going above 5, we do not consider the solution |
| | | as an optimal one. |

TABLE 3
Example: Problem 2 (easier)

2 types of logical constraints: preceding, following
Given logical constraints in the system (used as given value to our model):

A precedes B, C precedes B

Given numerical constraints in the system:

| | |
|---|---|
| Type Baseline: | 1, 2, 3 |
| Type second | A (square of the baseline), B (third of the baseline), C |
| order: | (baseline) |
| Type Level F1 | Minimize the sum of the intervals second order values |

Our system will find the optimal solution(s) of this problem and these constraints

1. We claim an original method based on a combination of logical and numerical constraints, such as presented in this application, that can be at the same time very specific and very general, to mathematically model real life problems of complex sequencing optimization, in combining logical and numerical constraints in an optimal way, and in providing the user of our method a simple methodology and a simple approach (see for example a user interface with preselected choices) to describe complex problems of tasks sequencing optimization.

2. We claim a method that can be used at the core of many higher applications or even electrical machine (e.g. computer) specialized in the management decision support for the resolution and the optimization of problems involving intervals sequencing solutions and their organization under easy and complex constraints.

3. We claim a general method to translate with a mathematic model, complex problems of intervals sequencing, describing how intervals relate to each others in using a combination of logical and numerical constraints, adaptable to almost all needs of any real life situation in the world of tasks sequencing optimization, for which our system applies.

4. We claim a hierarchy and structure to organize various types of constraints to easily model complex problem of intervals sequencing optimization that can apply to any type of problems

5. We claim a core methodology that can be used as a tool to support decisions for complex projects for project managers

6. We claim a unique approach to combine various methodologies that until now remained separated and limited to their own very specific areas of application.
